(19) United States
(12) Patent Application Publication
(10) Pub. No.: US 2011/0309096 A1
(43) Pub. Date: Dec. 22, 2011

(54) FOOD AND CONDIMENT CONTAINER

(76) Inventor: Dale M. Jones, Marina del Rey, CA (US)

(21) Appl. No.: 12/819,013

(22) Filed: Jun. 18, 2010

(51) Int. Cl. B65D 25/00; B23P 17/04

(52) U.S. Cl. 220/737; 220/694; 29/428

(57) ABSTRACT

A combination food and condiment container comprising: a food container with an open top; a condiment container designed so that manual pressure will expel condiment from it; a condiment delivery tube; and a sanitary seal. One end of the tube is attached through a wall of the condiment container. The other end of the tube is positioned for delivery of the condiment to the food inside the food container. The sanitary seal is removably attached to the other end of the tube. The tube is bendable and rotatable. The food and condiment containers are attached together a flange on the condiment container and a mating slide on the food container; contact adhesive; a strip of hook and loop fastener; etc. The condiment container may be a flexible pouch or a syringe. Alternatively, the flexible pouch could be surrounded by an enclosure and a linkage provided so that pressure can be applied from outside of the enclosure to the pouch inside the enclosure. A hole may also be provided through a wall of the food container so that the tube may be passed through the hole.

### BACKGROUND OF THE INVENTION

(1) Field of the Invention

The present invention relates to the field of food service and more particularly to the dispensing of condiments to be eaten with food.

(2) Description of the Related Art

People like to eat French fries, chips, onion rings and similar finger foods. They also like to dip such foods in some sort of sauce or condiment, such as vinegar, ketchup, mustard, barbeque sauce, cheese sauce, etc. Such sauces are frequently contained in plastic packets or cups.

The plastic packets are always hard to open resulting in sauce on the fingers or clothing. And there is frequently no surface to squeeze the sauce onto.

Plastic cups are covered with a seal which must be removed and discarded. Removing the seal sometimes also results in sauce on the fingers or clothing.

A number of inventors have tried to solve these problems by providing combination food and condiment containers.

U.S. Pat. No. 7,520,417 discloses a food container in combination with a condiment container having a lip, a lower lip edge and a top edge. The food container includes at least one wall. A bottom connected to the wall defines a containment space. A slit formation is formed in the wall; the slit formation has a lower slit and an upper slit substantially parallel to the lower slit. The slits define a loop that is displaceable into the containment space for supporting the condiment container by urging the condiment container against the wall. The lower slit defines a wall lower ledge disposed for supporting the lower lip edge of the condiment container.

U.S. Pat. No. 7,246,716 discloses a disposable cup lid for placement onto the rim of a drinking cup has a cover portion having a drinking access port and a condiment opening, a rim portion, a reclosable and tearable fold-back condiment tab, a hinge, a post and a recess. The cup lid is structured in such a manner that when the condiment opening is not in use, the condiment opening is reclosable by the condiment tab.

U.S. Pat. No. 7,175,042 discloses a disposable cup lid for placement onto the rim of a drinking cup is provided. The cup lid comprises a cover portion having a drinking access port and a condiment opening, a rim portion, and a flexible arm having a sealing member. The cup lid is structured in such a manner that when the condiment opening is not in use, the condiment opening is sealably closed by the sealing member of the flexible arm.

U.S. Pat. No. 6,932,231 discloses a spill-resistant beverage cup lid which includes a well for adding liquid or powder condiments to a hot beverage and which also serves as a drinking portal is described. The well includes a plurality of apertures in a side wall of the well allowing the condiments to mix with the beverage. In an alternative embodiment, the well further includes a removable flap.

U.S. Pat. No. 6,863,178 discloses an arrangement of individual condiment serving packets in an outer container is provided having an approximately cylindrical container with at least four dual-packet sheets within said container. Each dual-packet sheet has a pair of individual condiment-filled packets each having a condiment-filled portion, said packets having a weakened tear-line in an unfilled medial portion of the sheet between them for manual separation of said packets for individual use. The dual-packet sheets are arranged with their condiment-filled portions in opposed front-to-back contact with their medial portions in parallel alignment and pinched closely together or in contact so that the condiment-filled portions are arranged generally like spokes on a wheel sized so as to fit into said approximately cylindrical container and to be thereby maintained in said approximately circular arrangement by said outer approximately cylindrical container.

U.S. Pat. No. 6,755,305 discloses a condiment container having a base and an upwardly extending sidewall that together define a storage space. The upwardly extending sidewall terminates in a perimeter lip that defines an opening for accessing the storage space. The condiment container also includes an attachment arm extending downwardly from the perimeter lip to a terminal end. A nesting aperture is positioned behind the attachment arm to enable nesting.

U.S. Pat. No. 6,612,485 discloses a food container with an integral loop member for securely holding a condiment container, allowing the two to be transported as one item. The container is formed from a first portion of a blank and has a continuous lip. The loop member is formed from a second portion of the blank and distinct from the first portion of the blank. The loop extends from an exterior surface of the container and no part of the loop member contacts the lip. A method for forming the container from one blank is also disclosed.

U.S. Pat. No. 6,427,684 states that the problem of this invention is to so further develop a discharge apparatus according to the preamble that it is possible during each individual actuating stroke to reliably discharge a predetermined volume of medium. A discharge apparatus for media according to the invention has a casing, on which is located an actuator. During each actuator actuation an actuating stroke takes place and consequently a given volume of the medium stored in the casing is discharged. According to the invention the gravity dependently operating blocking means are constructed in such a way that they can block the performance of an actuating stroke as a function of the spatial position of the discharge apparatus.

U.S. Pat. No. 6,419,153 discloses a combination food container and sealed condiment dispenser, in which a sealed condiment dispenser which is fixedly attached to a food container dimensioned to house a finger food.

U.S. Pat. No. 6,394,338 discloses a construction for a single piece blank and a container formed therefrom. The container is convertible between a single-compartment container and a multiple-compartment container. The container is characterized by having a rear panel defining a lateral slit therein and a front panel perforated and scored to define a converting flap hinged to the front panel along a lateral fold line. The container may be converted to a multiple-compartment container by separating the converting flap from the front panel along the perforation row, folding the converting flap along the lateral fold line, positioning the convertible flap between the front panel and the rear panel to be received through the slit. Thus, an upper compartment and a lower compartment are provided, separated by the converting flap.

U.S. Pat. No. 6,394,297 discloses a container attachment device for attaching a container to a storage container having first and second attachment elements that can be attached to the storage container and the container, respectively, to make them readily interconnectable. The first attachment element has a first anchor having a first adhesive backing for attaching the first attachment element to the storage container; and the first attachment element has a rigid tongue extending upwardly. The second attachment element has second and third anchors connected by a bridge. The second and third anchors have second and third adhesive backings, respectively, for attaching the second attachment element to the storage container. The bridge is shaped to connect the second and third anchors such that when the second and third anchors are attached to the container by the second and third adhesive backings, the rigid tongue of the first attachment element can be removably engaged between the bridge and the container.

U.S. Pat. No. 6,386,443 discloses in combination, a food container and a condiment container. The food container includes a front panel, a back panel attached to the front panel by at least one side panel and a bottom panel for defining an enclosure therebetween. A cut-out portion is provided in the at least one side panel and is attached to the front panel and to the back panel and extends into the enclosure. The condiment container includes a top end, a bottom end, and side walls sized for placement against a side panel of the food container. A clip structure is positioned at the top end for attaching and suspending the condiment container to the at least one side panel of the food container. The cut-out portion is sized and positioned for securing the condiment container near the bottom end in coaction with the clip structure.

U.S. Pat. No. 6,364,112 discloses a condiment container that attaches to other objects. In one embodiment of the invention, the condiment container is a portable and disposable container that adhesively attaches to the interior of a vehicle. This embodiment facilitates the eating of food and snacks while driving. This embodiment includes a container body that holds the condiment. The container body can have any shape (e.g., it can be in a shape of a packet or a bucket). This container includes an attaching arm that rotatably couples to the container body, and has an adhesive material on one of its sides. A consumer can attach the container to a surface in the vehicle by rotating the arm away from the container body and abutting the adhesive side of the arm to the vehicle surface.

U.S. Pat. No. 6,360,944 discloses a container with a foldable holder for holding both a primary substance and a secondary substance. The container has a volume defined by a substantially upright sidewall and a bottom to receive the primary substance such as French fries therein. The container also has a lip extending from the upright sidewall upwardly. The lip has an opening and can be folded outwardly to form a holder for receiving a second container containing the secondary substance such as ketchup therein in the opening of the lip.

U.S. Pat. No. 6,230,969 discloses a food container having a sauce container coupled thereto. The food container includes an open top adapted for received food articles. The sauce container also includes an open top. Coupling structure suited for yielding either a detachable or permanent coupling of the two containers is mechanically associated with the two containers.

U.S. Pat. No. 6,182,890 discloses a collapsible, disposable food container including a main body which is selectively adjustable between an operative, open position and a collapsed, flat position thereof. The container is constructed from a unitary piece of flat stock material folded to define front, back, side, and bottom walls. The container includes a main body having a bottom portion which is shaped substantially as a truncated cone, when the container is in its operative position, such that the bottom portion may be inserted in and stably engage the walls of a circular opening, such as a vehicle cup holder. Most preferably, the lower portion of the main body fits within a circular area 2.75 inches in diameter. In a preferred embodiment of the invention, each side wall includes an indentable gripping brace region, intermediate of upper and lower portions of the side wall, which can be flexed inwardly of the upper and lower portions of the side wall, when inwardly directed pressure is applied thereto. It is preferable that the indentable gripping brace regions be substantially football shaped. In an optional embodiment of the invention, the container further includes a secondary, body integrally formed with the main body, for holding auxiliary foodstuffs such as condiments. Where used, the secondary body defines a pocket connected to one of the front, back or side walls of the main body.

U.S. Pat. No. 6,076,700 discloses a condiment container with clip for attaching to the side of a food container such as a French-fry box or a sandwich container of the type typically used in fast food restaurants. The condiment container includes a bottom wall with a perimeter side wall upwardly extending around the outer perimeter of the bottom wall. The perimeter side wall has an upper edge defines a top opening. A clip is provided having an extent at the top end of the clip which is coupled to the perimeter side wall adjacent the upper edge of the perimeter side wall. The extent spaces the clip apart from the perimeter side wall to define a slot therebetween adapted for extending a side of a food container therein such that the extent rests on the food container.

U.S. Pat. No. 5,720,429 discloses food container including a paperboard container with front and rear panels and collapsible side walls and collapsible bottom, permitting the container to be flattened to a nestable storage position. A flip-out pocket is operably mounted within the container, with a pocket panel having a forward edge mounted to the front panel, a rearward edge mounted to the rear panel, and a bottom edge mounted to the side wall. A central hinge extending from the top to the bottom of the pocket panel, and hinged connections of the edges of the pocket permit the pocket panel to be moved from a storage position flush against the side wall to an operable position with the upper edge spaced away from the upper edge of the side wall.

U.S. Pat. No. 5,626,283 discloses a combination container for food and condiments formed from a one piece blank of paperboard material. The finished container includes a first compartment in the shape of a scoop for holding the food product and a second compartment in the form of a pouch which can be extended outwardly from the first compartment for condiments. The second compartment is collapsed against one wall of the first compartment when not in use for easy stacking of the containers.

U.S. Pat. No. 5,417,364 discloses a double basket providing separate containers for a primary substance (e.g., French fries) and an associated condiment substance (e.g., ketchup in a cup). The secondary basket has a small auxiliary wall supported by the principle basket's wall panel for juxtaposition along the primary basket's wall panel, but movable to a basket-open position away from that closed position. The auxiliary wall and its support arms provide, nevertheless, that in the closed-pocket condition the pocket components pose significantly no deterrence to what is provided to be a “nestable” stackable feature of a plurality of baskets.

U.S. Pat. No. 4,955,528 discloses a paperboard container for food and condiments. The container is formed from a one piece blank cut from rectangular paperboard stock. The finished container has a first receptacle and an adjacent second fluid tight receptacle for condiments. The finished container may be collapsed to a flat condition for storage and may be stacked one upon another in the open position.

U.S. Pat. No. 4,644,732 discloses a disposable, portion controlled container for condiments and other comestibles formed from heat sealable material is disclosed, featuring an easy opening of the container by virtue of a unique fold and heat seal made at one corner of the container during manufacture. An inside reverse fold is made in one corner of the container and a heat seal made along a four thickness layer of this inside reverse fold defines a tear line, stronger than the adjacent material. A tab extended from this four thickness heat seal of the inside reverse fold provides the means for opening the container along the tear line. The size of the opening in the container is controlled by the initial width of material used to form the inside reverse fold.

United States Patent Application No. 20030141355 discloses a French fry and condiment holder having a wall with a pair of parallel slits. A condiment sleeve containing ketchup or another condiment may be inserted into a loop formed in the wall by deforming the wall at the slits. The condiment sleeve has a flat bottom and can stand upright.

None of these prior art inventions allows for attachment of a condiment container to a food container in a way which provides easy application of the condiment to the food in the container.

Development of a combination condiment and food container and a method of making it which allows for attachment of a condiment container to a food container in a way which provides easy application of the condiment to the food in the container represents a great improvement in the field of food service and satisfies a long felt need of the public.

### SUMMARY OF THE INVENTION

The present invention is a combination food and condiment container and method of making it which provides easy application of the condiment to the food in the container. This invention preferably comprises: a food container with an open top; a condiment container designed so that manual pressure will empty it of a condiment; a condiment delivery tube; and a sanitary seal. The invention could also comprise a condiment container designed so that manual pressure will empty it of a condiment; a condiment delivery tube; and a sanitary seal. The tube and container can be provided as separate elements which are joined by the user just prior to use. Alternatively, they could be provided as one unit.

Regardless how the invention is provided, one end of the tube is attached through a wall of the condiment container. The tube is designed so that the other end of the tube is positioned for delivery of the condiment to the food inside the food container. The sanitary seal is removably attached to the other end of the tube.

The tube is preferably designed to be bendable and may also be designed to rotate. The food and condiment containers may initially be separated. The two may be attached together by any convenient means such as a flange attached to the condiment container and a mating slide attached to the food container; contact adhesive; a strip of hook and loop fastener; and a flexible hook on the container designed to clip onto a side of the container.

The condiment container may be a flexible pouch, to which manual pressure can be applied for dispensing the condiment. Alternatively, the condiment container could be a syringe. Alternatively, the flexible pouch could be surrounded by an enclosure and a linkage provided so that pressure can be applied from outside of the enclosure to the pouch inside the enclosure.

A hole may also be provided through a wall of the food container so that the tube may be passed through the hole.

The combination food and condiment container may be constructed by:

attaching one end of the condiment delivery tube through a wall of the condiment container;

removably attaching the sanitary seal to the other end of the condiment delivery tube; and

attaching the condiment container to the food container.

An appreciation of the other aims and objectives of the present invention and an understanding of it may be achieved by referring to the accompanying drawings and description of a preferred embodiment.

### BRIEF DESCRIPTION OF THE DRAWINGS

FIG. 1 is a perspective drawing of one embodiment of this invention.

FIG. 2 is a perspective drawing of a preferred condiment container of this invention.

FIG. 3 is an enlarged perspective drawing of the delivery tube of this invention.

FIG. 4 is a cross section along the lines 4-4 of FIG. 1.

FIG. 5 is a perspective drawing of a second embodiment of this invention.

FIG. 6 is a perspective drawing of an alternate condiment container of this invention.

FIG. 7 is a cross section along the lines 7-7 of FIG. 6.

FIG. 8 is a cross section of condiment container in the form of a syringe.

FIG. 8 is a cross section of an alternate syringe design for the condiment container.

FIG. 9 is a cross section of another syringe design for the condiment container.

FIG. 10 is a side view of a condiment container attached to a wall of a food container with clip(s).

FIG. 11 is a cross sectional view of an alternate embodiment comprising a separate condiment container and delivery tube.

### DETAILED DESCRIPTION OF THE PREFERRED EMBODIMENT

While the present invention is described herein with reference to illustrative embodiments for particular applications, it should be understood that the invention is not limited thereto. Those having ordinary skill in the art and access to the teachings provided herein will recognize additional modifications, applications, and embodiments within the scope thereof and additional fields in which the present invention would be of significant utility.

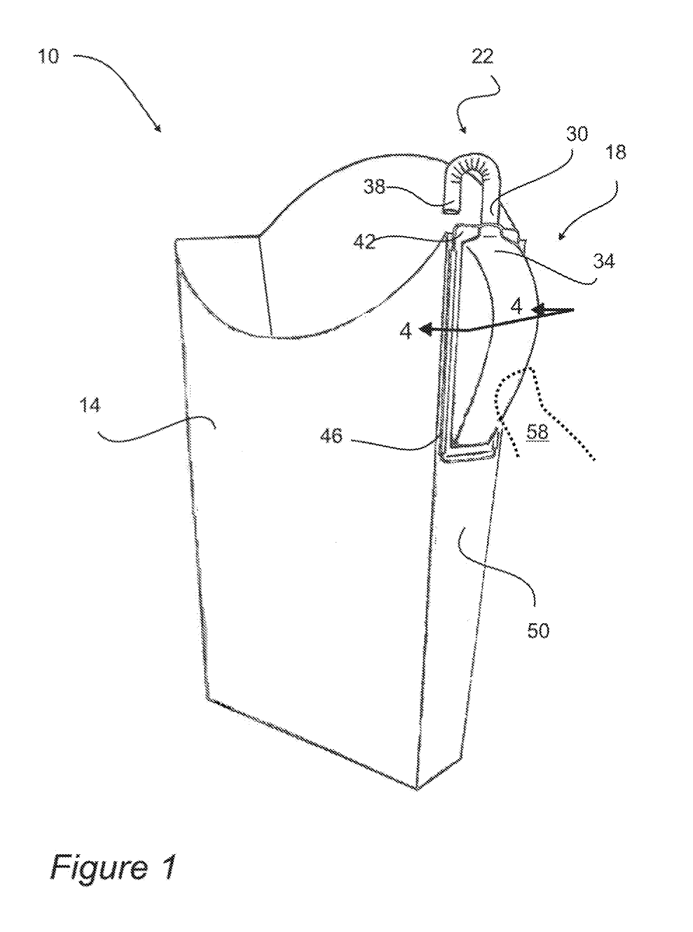

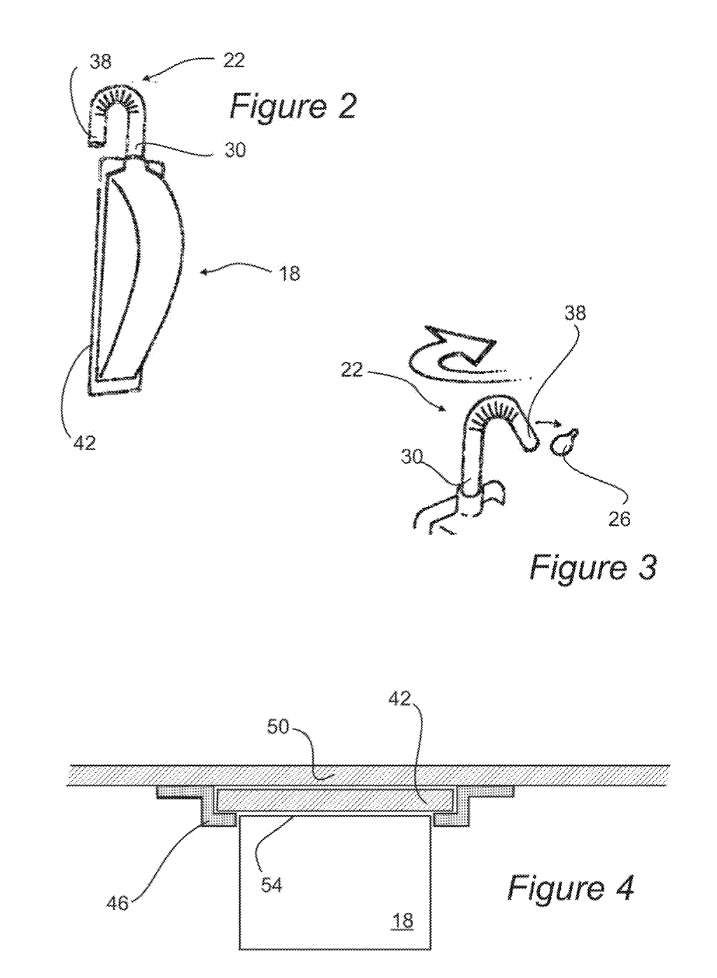

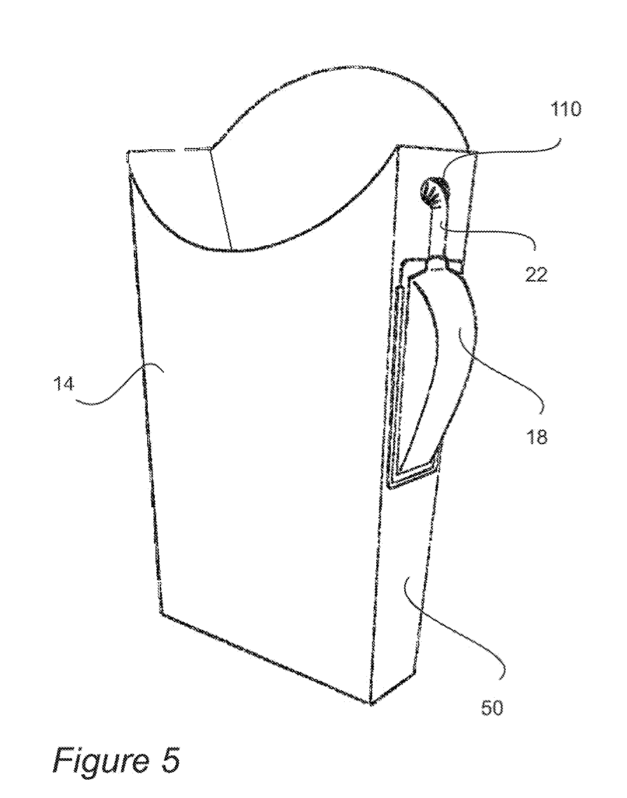

Referring to FIGS. 1, 2 and 3, this invention 10 comprises: a food 14 container with an open top; a condiment container 18; a condiment delivery tube 22; and a sanitary seal 26. Alternatively, the invention 10 can comprise a condiment container 18; a condiment delivery tube 22; and a sanitary seal. One end 30 of the tube 22 is attached through a wall 34 of the condiment container 18. The tube 22 is preferably designed to be bendable with its other end 38 positioned for delivery of the condiment to the food inside the food container 14. The tube 22 may also be rotatable, as illustrated by the arrow on FIG. 3. The sanitary seal 26 is removably attached to the other 38 end of the tube.

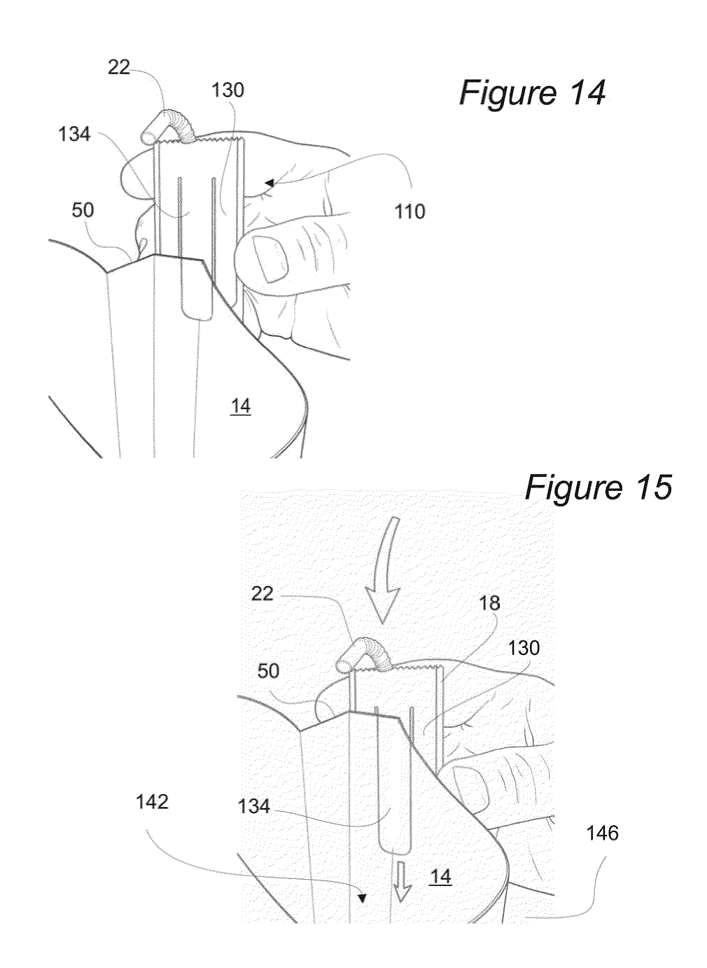

The food 14 and condiment 18 containers may initially be separated. The two may be attached together by any convenient means such as a flange 42 attached to or made integrally with the condiment container 18 and a mating slide 46 attached to the food container 14; contact adhesive; and a strip of hook and loop fastener. Those familiar with the art to which this invention pertains will recognize that other means of fastening could be used. For example, as shown in FIG. 10, one or more springy clips 110 could be attached to the rear wall 54 of the condiment container 18. The clip(s) 110 fit over and retain the container 18 to a wall 50 of the food container 14.

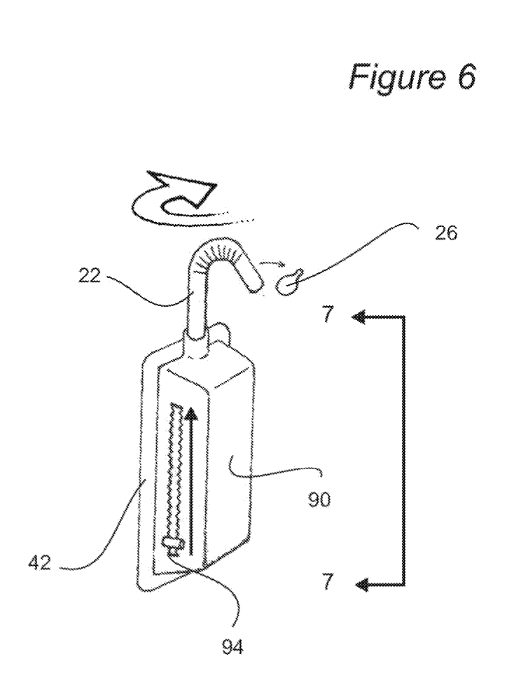

FIG. 4 better illustrates the flange 42 and slide 46 attachment means. The slide 46 is attached to a wall 50 of the food container 14. The flange 42 is attached to the rear wall 54 of the condiment container 18.

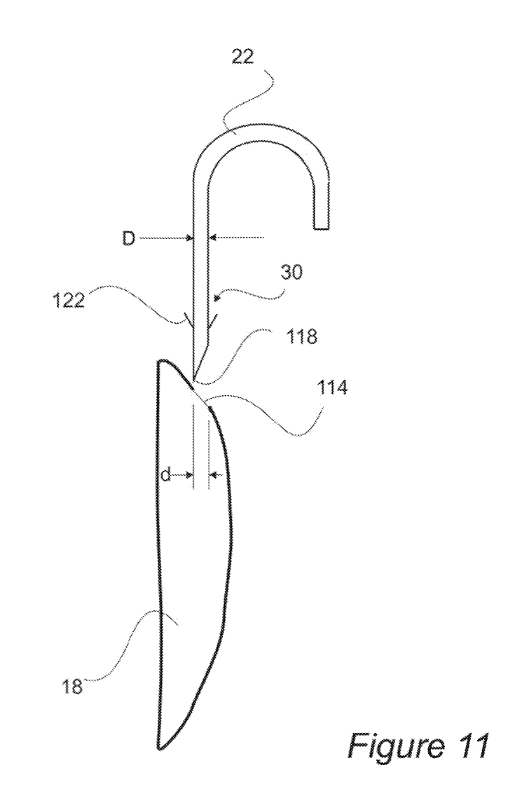

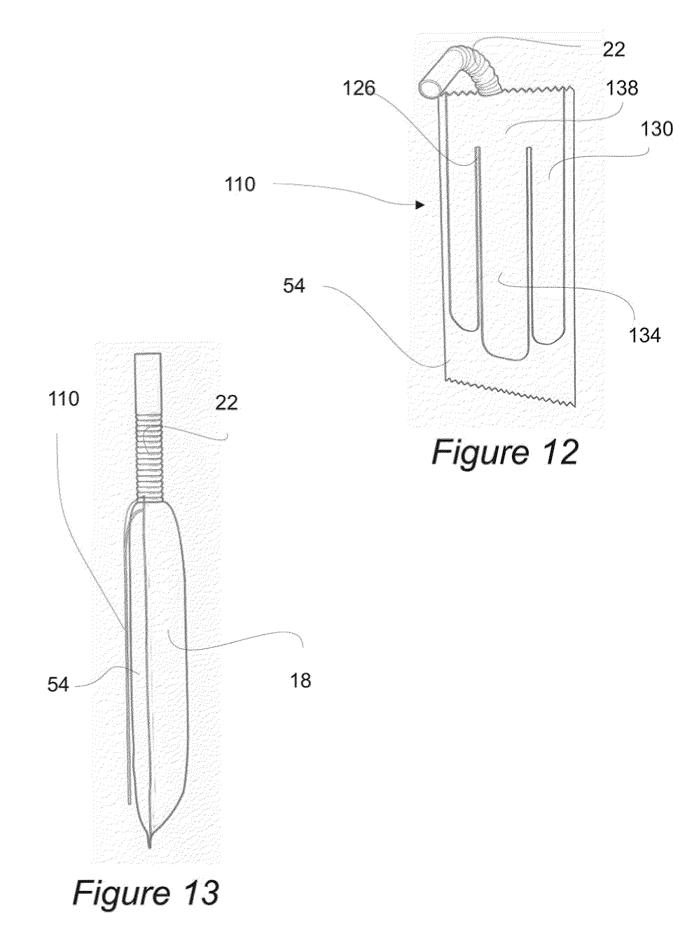

As illustrated in FIG. 1, the condiment container 18 may be a flexible pouch, to which manual pressure, as illustrated by the thumb 58, can be applied for dispensing the condiment. Alternatively, the condiment container could be a syringe. Several different designs of syringe-like condiment containers 18a, 18b are illustrated in FIGS. 8 and 9.

The embodiment 18a illustrated in FIG. 8 includes a barrel 62 inside an enclosure 66. A dogleg plunger 70 is provided so that upwards pressure, illustrated by the arrow, can be applied on the plunger head 74 from outside the enclosure 66. As can be seen from FIG. 8, this version dispenses the condiment upwards into the tube 22.

In the embodiment 18b illustrated in FIG. 9 downwards pressure, as illustrated by the arrow, is applied to the plunger 78 and head 82, and condiment is dispensed into a reversing tube 86, which is connected to or made integral with the tube 22.

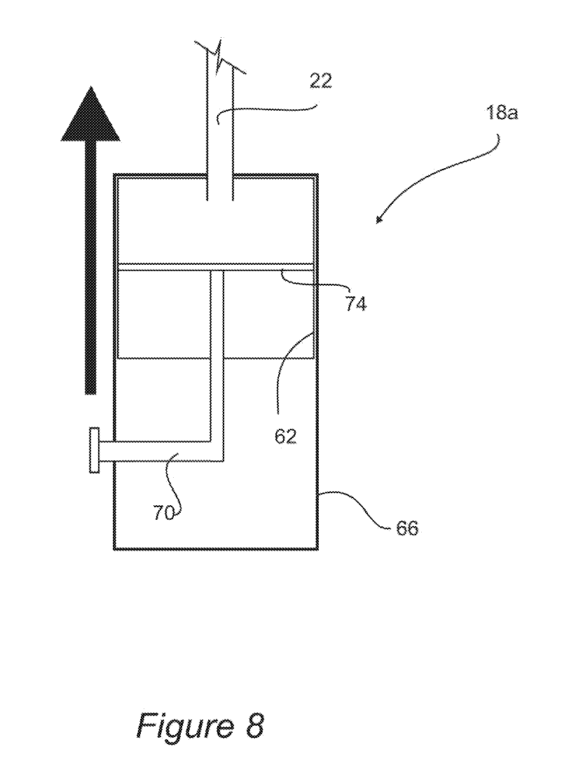

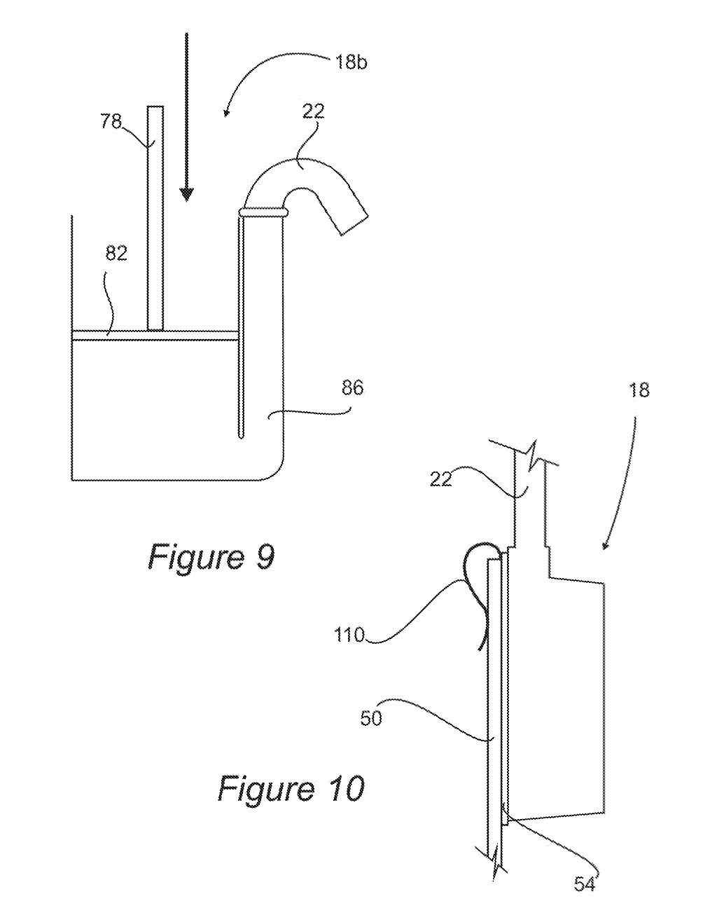

Alternatively, as illustrated in FIGS. 6 and 7, the flexible pouch 18 could be surrounded by an enclosure 90 and a linkage 94 provided so that pressure, preferably upwards, as illustrated by the arrow, can be applied from outside of the enclosure to the pouch 18 inside the enclosure 90.

FIG. 7 also describes a method of attaching the tube 22 through the top wall 34 of the pouch 18. In this design the top wall 34 of the pouch 34 is at least partially attached to the top surface 102 of the enclosure 90. Holes are provided so that the end 30 of the tube 22 can pass through the top wall 34 and top surface 102. The bottom of the tube 22, which is below the wall 34 and surface 102 is provided with a stop flange 98. A stop ring 106 is attached to the end 30 above the top surface 102. In this way the tube 22 is retained in place, communicates with the condiment and can rotate. Those familiar with the art to which this invention pertains will recognize that alternative mechanisms are able to provide the same functionality.

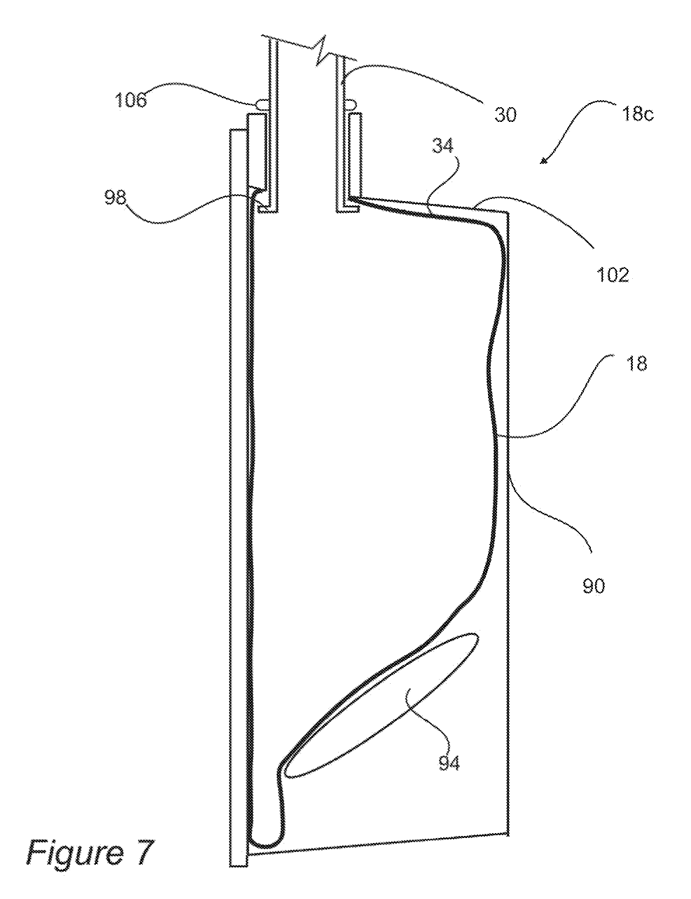

FIG. 5 illustrates a variation of this invention in which a hole 110 is cut through a wall 50 of the food container 14 through which the tube 22 is be passed.

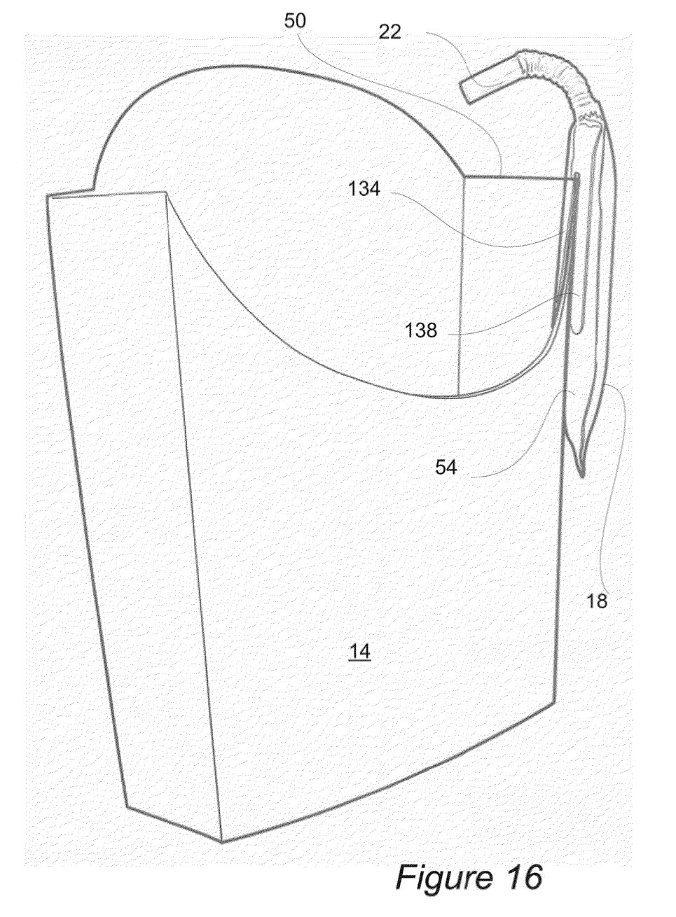

FIG. 11 illustrates a variation of this invention comprising an initially separated condiment container 18 and delivery tube 22. This variation could be applied to the embodiments illustrated in FIGS. 1 and 8. The container 18 will include a window 114 made of soft, thin material and the straw 22 will have a pointed end 118. This construction is similar to that currently used in juice boxes except that the straw 22 and window 114 will be constructed so that they cannot easily be separated once the pointed end 118 of the tube 22 has been inserted through the window 114. Preferably, as in juice boxes, the tube 22 will be supplied entirely wrapped in plastic.

One way of accomplishing this is to make the diameter D of the tube 22 just slightly less than the diameter d of the window 114 and include a number of springy barbs 122 on the tube 22 close to the pointed end 118. Then after the pointed end 118 pierces the window 114 the barbs 122 will flatten against the tube 22 as it passes through the window 114 and spring out again after the barbs 122 have passed through, thus holding the end 30 of the tube 22 inside the pouch 18. Those familiar with the art to which this invention pertains will doubtless be able to conceive of alternate constructions.

The combination food and condiment container 10 may be constructed by:

providing a separate, wrapped condiment delivery tube 22 and condiment container 18; or

attaching one end 30 of the condiment delivery tube 22 through a wall 34 of the condiment container 18 and removably attaching the sanitary seal 26 to the other end 38 of the condiment delivery tube 22.

A customer will purchase food in a container 14. Preferably the condiment container 18 will not be affixed to the food container 14. Preferably an assortment of containers 18 containing different condiments, such as ketchup, mustard, mayonnaise, etc. will be available for selection. The customer will then select a condiment container 18 containing his/her chosen condiment and affix it to the food container. If the tube 22 is separately provided, as illustrated in FIG. 11, the customer will insert its pointed end through the window in the condiment container. Then the customer will rotate and/or bend the tube 22 typically as shown in FIGS. 1 and 5. If provided, the customer will remove the sanitary seal 26. Finally the customer will dispense condiment from the condiment container 18 by applying manual pressure to the container 18, itself, similar to the way illustrated in FIG. 1; or by applying manual pressure to the linkage 94, shown in FIG. 6; or by applying manual pressure to the plungers 70, 78, illustrated in FIGS. 8 and 9.

The following reference numerals are used on FIGS. 1 through 10:
10 combination food and condiment container of this invention
14 food container portion of invention
18 condiment container portion of invention
18a upwards activated syringe like version of condiment container
18b downwards activated syringe like version of condiment container
18c enclosed version of condiment container
22 condiment delivery tube
26 sanitary seal
30 first end of tube
34 top wall of pouch
38 delivery end of tube
42 attaching flange
46 attaching slide
50 wall of food container
54 rear wall of condiment container
58 thumb
62 barrel
66 enclosure
70 dogleg plunger
74 plunger head
78 plunger
82 plunger head
86 reversing tube
90 enclosure
94 pressurizing linkage
98 stop flange
102 top wall of enclosure 90
106 stop ring
110 clip
114 window
118 pointed end
122 flexible barb

Thus, the present invention has been described herein with reference to a particular embodiment for a particular application. Those having ordinary skill in the art and access to the present teachings will recognize additional modifications, applications and embodiments within the scope thereof.

It is therefore intended by the appended claims to cover any and all such applications, modifications and embodiments within the scope of the present invention.

1. A combination food and condiment holder comprising:
a) a food container with an open top;
b) a condiment container designed so that manual pressure will expel condiment from it;
c) a condiment delivery tube having two ends, one end of which is designed to be attached through a wall of said condiment container; said condiment delivery tube further designed to deliver condiment to food contained within said food container when said one end is attached to said condiment container; and
d) a means for attaching said condiment container to said food container.

2. A combination food and condiment holder as claimed in claim 1 in which said condiment container and condiment delivery tube are attached to each other.

3. A combination food and condiment holder as claimed in claim 2 further comprising a sanitary seal, removably attached to the other end of said condiment delivery tube.

4. A combination food and condiment holder as claimed in claim 1 or 2 in which said condiment container comprises a flexible pouch.

5. A combination food and condiment holder as claimed in claim 1 or 2 in which said condiment container comprises a syringe.

6. A combination food and condiment holder as claimed in claim 1 or 2 in which said means for attaching is a flange attached to said condiment container and a mating slide attached to said food container.

7. A combination food and condiment holder as claimed in claim 1 or 2 in which said means for attaching is a contact adhesive.

8. A combination food and condiment holder as claimed in claim 1 or 2 in which said means for attaching is a strip of hook and loop fastener.

9. A combination food and condiment holder as claimed in claim 4 further comprising:
a) an enclosure surrounding said flexible pouch; and
b) a means for providing manual pressure on said pouch within said enclosure operated from outside said enclosure.

10. A combination food and condiment holder as claimed in claim 1 or 2 in which there is a hole through a wall of said food container and said condiment delivery tube passes through said hole.

11. A method of constructing a combination food and condiment holder comprising the steps of:
a) providing a food container with an open top;
b) providing a condiment container designed so that manual pressure will expel condiment from it;
c) providing a condiment delivery tube having two ends designed to deliver condiment to food contained within said food container; said condiment delivery tube further designed so that one end of said condiment delivery tube can be attached through a wall of said condiment container; and
d) attaching said condiment container to said food container.

12. A method as claimed in claim 11 further comprising the step of attaching said condiment container and condiment delivery tube to each other.

13. A method as claimed in claim 12 further comprising the steps of:
a) providing a sanitary seal; and
b) removably attaching said sanitary seal to the other end of said condiment delivery tube.

14. A method as claimed in claim 11 or 12 in which said condiment container comprises a flexible pouch.

15. A method as claimed in claim 11 or 12 in which said condiment container comprises a syringe.

16. A method as claimed in claim 11 or 12 in which said condiment container is attached to said food container via a flange attached to said condiment container and a mating slide attached to said food container.

17. A method as claimed in claim 11 or 12 in which said condiment container is attached to said food container via a contact adhesive.

18. A method as claimed in claim 11 or 12 in which said condiment container is attached to said food container via a strip of hook and loop fastener.

19. A method as claimed in claim 14 further comprising the steps of:
a) providing an enclosure designed to surround said flexible pouch;
b) providing a pressurizing means for providing manual pressure on said pouch within said enclosure operated from outside said enclosure;
c) surrounding said flexible pouch with said enclosure; and
d) installing said pressurizing means to said pouch through said enclosure;

20. A method as claimed in claim 11 or 12 further comprising the steps of cutting a hole through a wall of said food container and threading said condiment delivery tube through said hole.

21. A condiment holder comprising:
a) a condiment container designed so that manual pressure will expel condiment from it;
b) a condiment delivery tube having two ends, one end of which is designed to be attached through a wall of said condiment container; and
c) a means for attaching said condiment container to a food container; said condiment delivery tube further designed to deliver condiment to food contained within said food container when said one end is attached to said condiment container and said condiment container is attached to said food container.

22. A condiment holder as claimed in claim 21 in which said condiment container and condiment delivery tube are attached to each other.

23. A condiment holder as claimed in claim 22 further comprising a sanitary seal, removably attached to the other end of said condiment delivery tube.

24. A condiment holder as claimed in claim 21 or 22 in which said condiment container comprises a flexible pouch.

25. A condiment holder as claimed in claim 21 or 22 in which said condiment container comprises a syringe.

26. A condiment holder as claimed in claim 21 or 22 in which said means for attaching is a clip attached to said condiment container.

27. A condiment holder as claimed in claim 24 further comprising:
a) an enclosure surrounding said flexible pouch; and
b) a means for providing manual pressure on said pouch within said enclosure operated from outside said enclosure.

28. A method of constructing a condiment holder comprising the steps of:
a) providing a condiment container designed so that manual pressure will expel condiment from it; said condiment container further designed to attach to a food container; and
b) providing a condiment delivery tube having two ends designed to deliver condiment to food contained within said food container; said condiment delivery tube further designed so that one end of said condiment delivery tube can be attached through a wall of said condiment container.

29. A method as claimed in claim 28 further comprising the step of attaching said condiment container and condiment delivery tube to each other.

30. A method as claimed in claim 29 further comprising the steps of:
a) providing a sanitary seal; and
b) removably attaching said sanitary seal to the other end of said condiment delivery tube.

31. A method as claimed in claim 28 or 29 in which said condiment container comprises a flexible pouch.

32. A method as claimed in claim 28 or 29 in which said condiment container comprises a syringe.

33. A method as claimed in claim 31 further comprising the steps of:
a) providing an enclosure designed to surround said flexible pouch;
b) providing a pressurizing means for providing manual pressure on said pouch within said enclosure operated from outside said enclosure;
c) surrounding said flexible pouch with said enclosure; and
d) installing said pressurizing means to said pouch through said enclosure.

34. A combination food and condiment holder as claimed in claim 1 or 2 in which said means for attaching is a clip.

35. A combination food and condiment holder as claimed in claim 11 or 12 in which said means for attaching is a clip.

36. A combination food and condiment holder as claimed in claim 21 or 22 in which said means for attaching is a clip.

37. A combination food and condiment holder as claimed in claim 28 or 29 in which said means for attaching is a clip.
